(19) United States
(12) Patent Application Publication
(10) Pub. No.: US 2006/0055979 A1
(43) Pub. Date: Mar. 16, 2006

(54) Error diffusion control device and method for video apparatus

(75) Inventor: Sung Woo Tak, Gumi-si (KR)

Correspondence Address: FLESHNER & KIM, LLP, P.O. BOX 221200, CHANTILLY, VA, 20153, US

(73) Assignee: LG ELECTRONICS INC.

(21) Appl. No.: 11/180,599

(22) Filed: Jul. 14, 2005

(30) Foreign Application Priority Data
Sep. 13, 2004 (KR) 10-2004-0073017

(51) Int. Cl. G06F 15/00

(52) U.S. Cl. 358/3.03; 358/1.9

(57) ABSTRACT

An error diffusion control device and method for a video apparatus is provided for reducing contour noise in a displayed picture. In the method, video data is stored in a memory, and the ratio of black data to the stored video data is determined, where the black data represents black color in the stored video data. The black data ratio is compared with at least one reference ratio, and an error diffusion function for the video data is controlled according to the compared result.

This application claims the benefit of Korean Patent Application No. 10-2004-0073017, filed on Sept. 13, 2004, which is hereby incorporated by reference as if fully set forth herein.

### BACKGROUND OF THE INVENTION

1. Field of the Invention

The present invention relates to a video apparatus, and more particularly, to a device and method for controlling error diffusion in a video apparatus.

2. Discussion of the Related Art

Video apparatuses, which are devices for displaying pictures, include cathode ray tubes (CRT), liquid crystal displays (LCD), and plasma display panels (PDP). PDPs represent gray levels on a frame by frame basis, each frame including a plurality of subfields, to display pictures on the screen. It is essential for PDPs to include an error diffusion function for removing contour noise appearing on the screen. Contour noise refers to abnormal appearance of the contour or boundary of an image displayed on the screen when the gray level of the screen varies. Specifically, when the gray level varies, the color of the contour or boundary of the image is displayed as white or black.

In PDPs, discharges occur on a frame by frame basis (i.e., in units of the display period), and the display luminance is determined based on the number of discharges. As shown in FIG. 1A, one frame includes a plurality of discharge periods (hereinafter, it is assumed that one frame is composed of 8 subfields), and the discharge periods have different numbers of discharges. 0 to 255 discharges occur during one frame that includes 8 discharge periods, and the discharges are directly associated with changes in the gray level.

FIG. 1B shows actual discharge periods when the gray level is changed from “128” to “127”. In this case, the gray level in a unit time instantaneously increases so that it appears that 255 discharges occur, and the gray level is changed from “128” to “255” and then drops to “127”. A phenomenon referred to as “contour noise” occurs in this procedure. The following details the reasons why the phenomenon is referred to as contour noise. If an image on the screen is moved to the left after the left half of the screen was displayed by a gray level of 128 and the right half thereof was displayed by a gray level of 127, a white stripe appears on the original boundary of the image on the screen. On the contrary, in the case where the gray level is changed from 127 to 128 as shown in FIG. 1C, the original boundary of an image on the same screen appears as a black stripe if the image is moved to the right.

PDPs must carry out inverse gamma correction since PDPs have no gamma characteristics, contrary to display apparatuses such as CRTs. However, contour noise occurs as the gray level is reduced in the inverse gamma correction procedure. Thus, it is essential for PDPs to perform an error diffusion process in which an error caused by inverse gamma correction is spread to adjacent pixels to restore the original picture luminance.

FIG. 2 is a block diagram showing a conventional error diffusion control device, and FIG. 3 is a flow chart showing a conventional error diffusion control method.

A controller 17 determines whether or not a received R/G/B signal has been subjected to an inverse gamma correction procedure (S11), and controls an error diffuser 11 according to the result of the determination. The error diffuser 11 receives the R/G/B signal, and detects a gray level error of each pixel in the R/G/B signal (S12). The error diffuser 11 diffuses the gray level error of each pixel to adjacent pixels under the control of the controller 17 (S13).

The error diffuser 11 then transmits the R/G/B signal, from which the gray level error has been removed, to the frame memory 15, and the frame memory 15 stores the R/G/B signal (S14).

Applying the error diffusion technique to a picture significantly reduces contour noise in the picture. However, since it carries out error diffusion on the entirety of a picture, the conventional video apparatus has a problem in that a portion, which is to be displayed in black, of a monochrome-based screen such as a product logo screen may be displayed brightly, compared to the original color, due to the error diffusion process.

### SUMMARY OF THE INVENTION

Accordingly, the present invention is directed to an error diffusion control device and method for a video apparatus that substantially obviates one or more problems due to limitations and disadvantages of the related art.

An object of the present invention is to provide an error diffusion control device and method for a video apparatus, which removes contour noise occurring in a picture when the picture is subjected to an error diffusion process.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an error diffusion control method for a video apparatus comprises the steps of storing video data in a memory; determining a ratio of black data to the stored video data, the black data representing black color in the stored video data; comparing the black data ratio with at least one reference ratio; and controlling an error diffusion function for the video data according to the compared result.

Preferably, the step of determining the ratio of the black data to the stored video data includes the steps of reading the stored video data from the memory in units of at least one frame; and determining the ratio of the black data to the stored video data in units of at least one frame.

Preferably, the step of determining the ratio of the black data to the stored video data includes the step of comparing a gray level of the stored video data with a reference gray level on a pixel by pixel basis.

Preferably, the step of comparing the black data ratio with the at least one reference ratio includes the step of comparing the black data ratio corresponding to each frame with the reference ratio or includes the step of comparing the black data ratio corresponding to an entire picture with the reference ratio.

Preferably, the step of controlling the error diffusion function for the video data according to the compared result includes the steps of turning off the error diffusion function if the black data ratio is equal to or higher than the reference ratio; and turning on the error diffusion function if the black data ratio is lower than the reference ratio.

In another aspect of the present invention, an error diffusion control device for a video apparatus comprises an error diffusion processor for performing an error diffusion function on video data; a memory for storing the video data output from the error diffusion processor; and a controller for comparing a ratio of black data to the stored video data with at least one reference ratio and controlling the error diffusion processor according to the compared result, the black data representing black color in the stored video data.

In still another aspect of the present invention, an error diffusion control method for a video apparatus comprises the steps of determining a ratio of black data to received video data, the black data representing black color in the video data; determining an error diffusion efficiency of the video data according to the black data ratio; and performing an error diffusion function for the video data according to the determined error diffusion efficiency.

Preferably, the step of determining the error diffusion efficiency of the video data according to the black data ratio includes the step of determining the error diffusion efficiency, on a frame by frame basis, according to the black data ratio corresponding to each frame or includes the step of determining the error diffusion efficiency of the video data according to the black data ratio corresponding to an entire picture.

In yet another aspect of the present invention, an error diffusion control device for a video apparatus comprising a controller for determining a ratio of black data to received video data, the black data representing black color in the video data, and determining an error diffusion efficiency of the video data according to the determined black data ratio; and an error diffusion processor for performing an error diffusion function for the video data according to the determined error diffusion efficiency.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A, 1B, and 1C are views showing the background art;

FIG. 2 is a block diagram showing a conventional error diffusion control device;

FIG. 3 is a flow chart showing a conventional error diffusion control method;

FIG. 4 is a block diagram showing an error diffusion control device according to the present invention;

FIG. 5 is a flow chart showing an error diffusion control method according to a first embodiment of the present invention;

FIG. 6 is a flow chart showing an error diffusion control method according to a second embodiment of the present invention; and

FIG. 7 is a flow chart showing an error diffusion control method according to a third embodiment of the present invention.

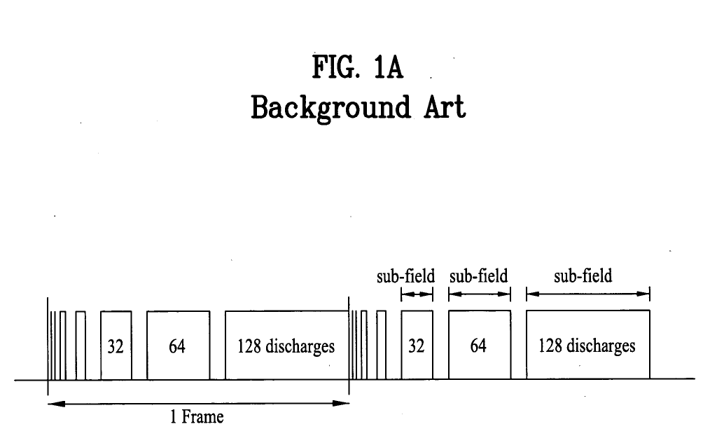

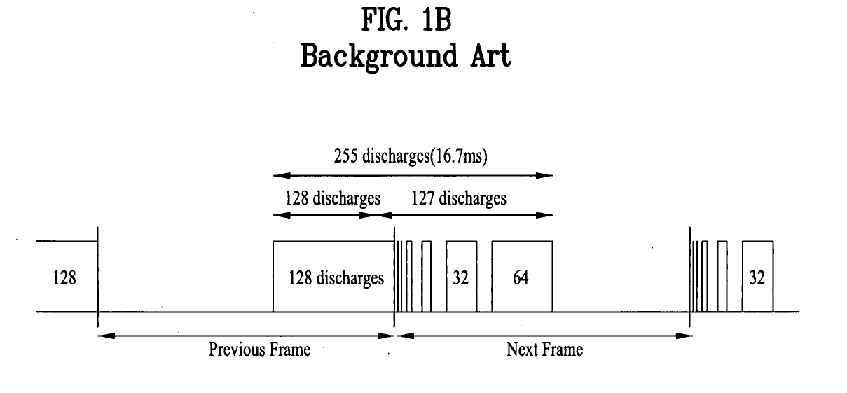

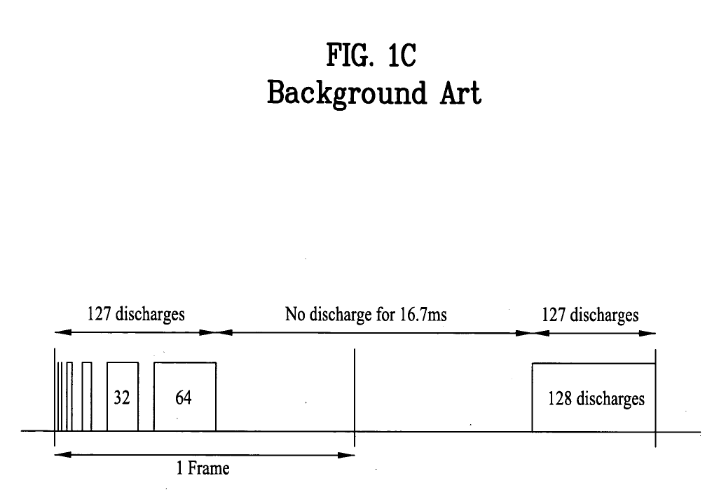

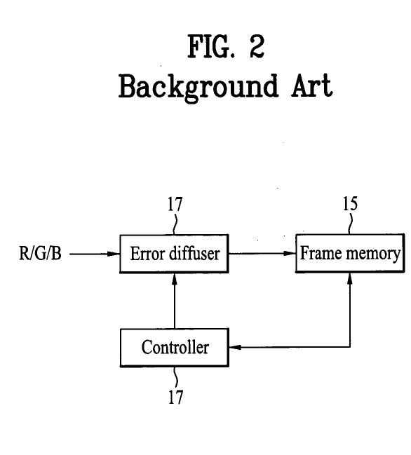

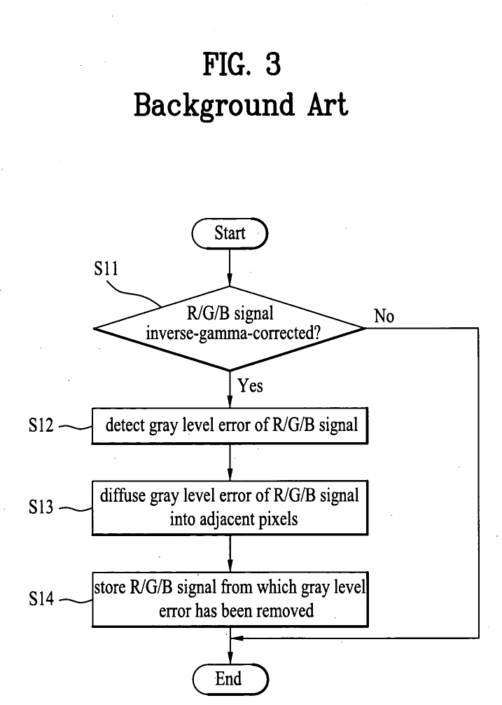

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

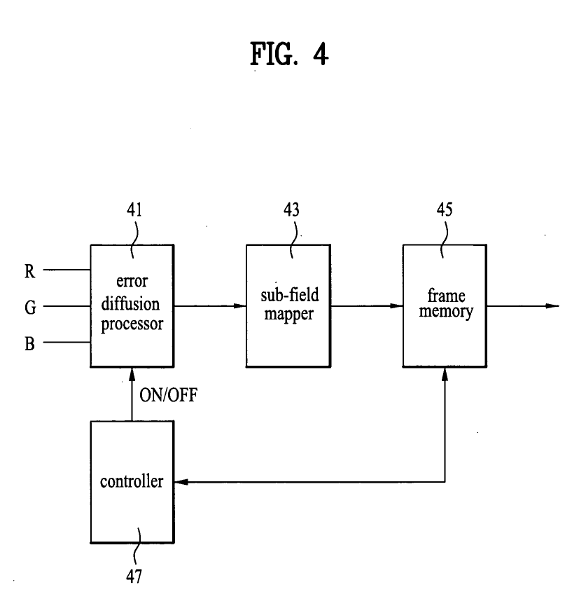

FIG. 4 is a block diagram showing an error diffusion control device for a display device according to the present invention. As shown in FIG. 4, the error diffusion control device according to the present invention comprises an error diffusion processor 41, a subfield mapper 43, a frame memory 45, and a controller 47.

The error diffusion processor 41 receives R/G/B video data, and corrects a gray level error of the received R/G/B video data. The error diffusion processor 41 is turned on or off under the control of the controller 47, or adjusts the efficiency of error diffusion or the gain of the error diffusion processor 41 under the control of the controller 47.

The subfield mapper 43 carries out mapping of video data output from the error diffusion processor 41 on a subfield by subfield basis, and outputs the mapped video data. The frame memory 45 stores the video data output from the subfield mapper 43 on a frame by frame basis.

The controller 47 determines whether or not the video data (of each pixel) stored in the frame memory 45 is black data that represents black color. Since the video data has been stored on a frame by frame basis, the determination of whether or not the video data is black data is performed on a frame by frame basis. To determine whether or not the video data is black data, the controller 47 compares the gray level of video data corresponding to each pixel with at least one reference gray level or with a reference range of gray levels.

The controller 47 determines the ratio of black data of a frame to total data of the frame. The controller 47 may sequentially determine black data ratios in units of one or more frames or may determine the black data ratio of the entire screen. The controller 47 compares the black data ratio with a reference ratio or with a reference ratio range. Then, the controller 47 turns on or off the error diffusion processor 41 or controls the gain of the error diffusion processor 41 according to the compared result.

The controller 47 includes a black data determination unit (or logic circuit) or software that compares a gray level of video data with a preset reference range of gray levels to determine whether or not the video data is black data.

Embodiments of an error diffusion control method for a display device according to the present invention will now be described.

### First Embodiment

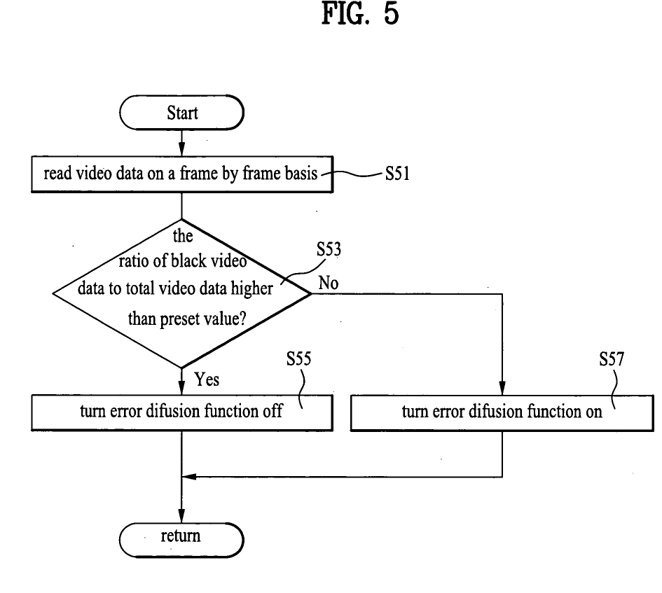

As shown in FIG. 5, the error diffusion processor 41 receives video data and performs error diffusion processing on the received video data, and then outputs it to the subfield mapper 43. The subfield mapper 43 carries out mapping of the video data transmitted from the error diffusion processor 41 on a subfield by subfield basis, and outputs the mapped video data to the frame memory 45. The frame memory 45 stores the video data received from the subfield mapper 43 on a frame by frame basis.

When the video data is stored in the frame memory 45 on a frame by frame basis, the controller 47 reads the video data from the frame memory 45 on a frame by frame basis (S51). The controller 47 may read the video data in units of two or more frames. The controller 47 then determines whether or not video data of each pixel belonging to the corresponding frame is black data. The controller 47 compares a gray level of video data corresponding to each pixel with at least one reference gray level or with a reference range of gray levels in order to determine whether or not the video data of each pixel is black data. For example, the controller 47 determines whether or not the gray level of the video data falls within a reference range of gray levels of 0 to 10.

When it is determined whether or not the video data of each pixel is black data, the controller 47 may determine the ratio of black data to the video data, where the black data represents black color in the video data. For example, the controller 47 may sequentially determine the ratios of black data to video data in units of one or more frames or may collectively determine the ratio of black data to video data of the entire screen. The controller 47 then compares the black data ratio with a reference ratio or with a reference ratio range (S53), and turns on or off the error diffusion processor 41 according to the compared result. For example, if the black data ratio is equal to or higher than the reference ratio (for example, 65%), the controller 47 deactivates the error diffusion processor 41 (S55), whereas, if the black data ratio is less than the reference ratio, the controller 47 activates the error diffusion processor 41 so that it operates normally (S57). In another example, if the black data ratio falls within the reference ratio range (for example, 60% to 70%), the controller 47 deactivates the error diffusion processor 41, whereas, if the black data ratio is less than the reference ratio or the minimum of the reference ratio range, the controller 47 activates the error diffusion processor 41 so that it operates normally.

If the error diffusion processor 41 is turned off, it does not perform error diffusion processing of video data. Since the purpose of the error diffusion processing is to restore luminance, which has been reduced due to a reduction in the gray level via inverse gamma correction, to the original luminance, error diffusion processing is not necessary if the ratio of black video data, upon which luminance has very little effect, is equal to or higher than a preset value. Video data, which must be displayed as black, may be displayed as a bright gray-level color other than black if error diffusion processing is performed on the video data for which error diffusion processing is unnecessary. Accordingly, if a large amount of black data is included in the video data, the error diffusion processor 41 is turned off as described above.

When the determination of whether or not error diffusion processing must be performed is made on a frame by frame basis, the above procedure of steps S51, S53, S55, and S57 is sequentially performed for video data of all frames.

### Second Embodiment

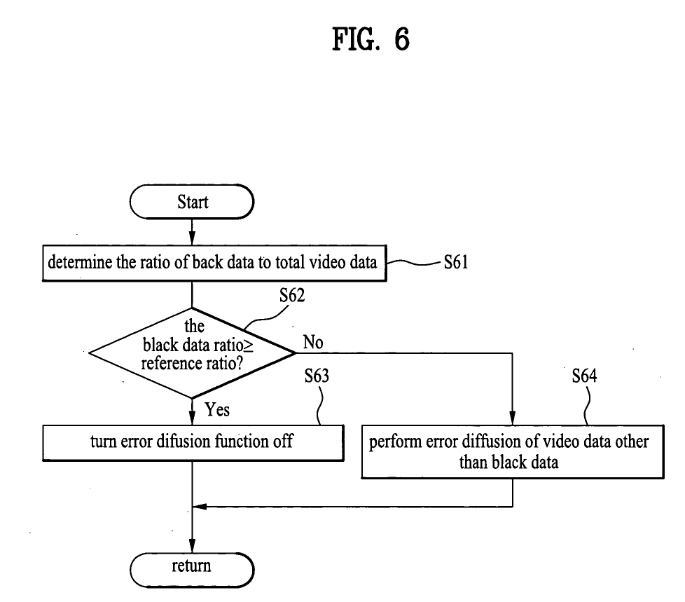

As shown in FIG. 6, if the error diffusion processor 41 receives video data, the controller 47 determines whether or not video data of each pixel is black data. To determine whether or not video data of each pixel is black data, the controller 47 reads video data input to the error diffusion processor 41 or reads video data stored in the frame memory 45. The controller 47 then compares a gray level of video data corresponding to each pixel with at least one reference gray level or with a reference range of gray levels. For example, the controller 47 determines whether or not the gray level of the video data falls within a reference range of gray levels of 0 to 10.

The controller 47 then determines the ratio of black data to the video data input to the error diffusion processor 41, where the black data represents black color in the video data (S61). For example, the controller 47 may sequentially determine the ratios of black data to video data in units of one or more frames or may collectively determine the ratio of black data to video data of the entire screen.

If the black data ratio is determined, the controller 47 compares the black data ratio with a reference ratio or with a reference ratio range (S62) , and controls the error diffusion processor 41 to selectively perform error diffusion of the video data according to the compared result. That is, the controller 47 performs error diffusion processing of video data other than black data according to the determined black data ratio. For example, if the black data ratio is equal to or higher than the reference ratio (for example, 65%), the controller 47 deactivates the error diffusion processor 41 (S63), whereas, if the black data ratio is less than the reference ratio, the controller 47 allows only video data, other than black data, to be subjected to the processing of the error diffusion processor 41 (S64).

### Third Embodiment

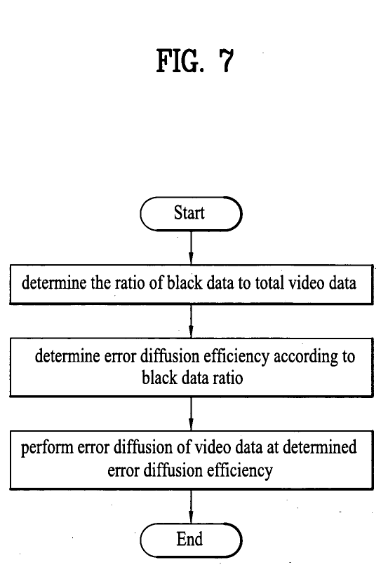

As shown in FIG. 7, if the error diffusion processor 41 receives video data, the controller 47 determines whether or not video data of each pixel is black data. To determine whether or not video data of each pixel is black data, the controller 47 reads video data input to the error diffusion processor 41 or reads video data stored in the frame memory 45. The controller 47 then compares a gray level of video data corresponding to each pixel with at least one reference gray level or with a reference range of gray levels. For example, the controller 47 determines whether or not the gray level of the video data falls within a reference range of gray levels of 0 to 10.

The controller 47 then determines the ratio of black data to the video data input to the error diffusion processor 41, where the black data represents black color in the video data (S71). For example, the controller 47 may sequentially determine the ratios of black data to video data in units of one or more frames or may collectively determine the ratio of black data to video data of the entire screen.

If the ratio of the black data to the video data is calculated, the controller 47 determines the efficiency of error diffusion or the gain of the error diffusion processor 41 according to the calculated black data ratio (S72). For example, if the calculated black data ratio is 60%, the error diffusion processor 41 sets the error diffusion efficiency or the gain of the error diffusion processor 41 to 60%.

The controller 47 may sequentially determine black data ratios and error diffusion efficiencies on a frame by frame basis or may determine a black data ratio and an error diffusion efficiency corresponding to the entire screen at once. Accordingly, the error diffusion processor 41 can process video data on a frame by frame basis according to the error diffusion efficiencies determined by the controller 47 or can process video data corresponding to the entire screen at once (S73).

As is apparent from the above description, according to the present invention, it is possible to reduce unnecessary error diffusion processes since whether or not error diffusion must be performed, error diffusion efficiencies, etc., are determined based on predetermined criteria. It is thus possible to reduce the occurrence of contour noise due to unnecessary error diffusion, thereby improving image quality.

Although the embodiments of the present invention have been described, it will be apparent to those skilled in the art that the present invention can be implemented in other specific forms without departing from the spirit or scope of the present invention. Therefore, the embodiments described above should be considered illustrative rather than restrictive. Accordingly, the present invention is not limited to the above description and various changes or modifications can be made within the scope of the appended claims and their equivalents.

What is claimed is:

1. An error diffusion control method for a video apparatus, the method comprising the steps of:
storing video data in a memory;
determining a ratio of black data to the stored video data, the black data representing black color in the stored video data;
comparing the black data ratio with at least one reference ratio; and
controlling an error diffusion function for the video data according to the compared result.

2. The error diffusion control method according to claim 1, wherein the step of determining the ratio of the black data to the stored video data includes the steps of:
reading the stored video data from the memory in units of at least one frame; and
determining the ratio of the black data to the stored video data in units of at least one frame.

3. The error diffusion control method according to claim 1, wherein the step of determining the ratio of the black data to the stored video data includes the step of:
comparing a gray level of the stored video data with a reference gray level on a pixel by pixel basis.

4. The error diffusion control method according to claim 1, wherein the step of comparing the black data ratio with the at least one reference ratio includes the step of:
comparing the black data ratio corresponding to each frame with the reference ratio.

5. The error diffusion control method according to claim 1, wherein the step of comparing the black data ratio with the at least one reference ratio includes the step of:
comparing the black data ratio corresponding to an entire picture with the reference ratio.

6. The error diffusion control method according to claim 1, wherein the step of controlling the error diffusion function for the video data according to the compared result includes the step of:
turning off the error diffusion function if the black data ratio is equal to or higher than the reference ratio.

7. The error diffusion control method according to claim 1, wherein the step of controlling the error diffusion function for the video data according to the compared result includes the step of:
turning on the error diffusion function if the black data ratio is lower than the reference ratio.

8. The error diffusion control method according to claim 1, wherein the step of controlling the error diffusion function for the video data according to the compared result includes the step of:
performing error diffusion on the video data other than the black data if the black data ratio is lower than the reference ratio.

9. An error diffusion control device for a video apparatus, the device comprising:
an error diffusion processor for performing an error diffusion function on video data;
a memory for storing the video data output from the error diffusion processor; and
a controller for comparing a ratio of black data to the stored video data with at least one reference ratio and controlling the error diffusion processor according to the compared result, the black data representing black color in the stored video data.

10. The error diffusion control device according to claim 9, wherein the controller reads the stored video data from the memory in units of at least one frame, and determines the ratio of the black data to the stored video data in units of at least one frame.

11. The error diffusion control device according to claim 9, wherein the controller compares a gray level of the stored video data with a reference gray level on a pixel by pixel basis to identify the black data representing black color in the stored video data.

12. The error diffusion control device according to claim 9, wherein the controller compares the black data ratio corresponding to each frame with the reference ratio.

13. The error diffusion control device according to claim 9, wherein the controller compares the black data ratio corresponding to an entire picture with the reference ratio.

14. The error diffusion control device according to claim 9, wherein the controller turns off the error diffusion function if the black data ratio is equal to or higher than the reference ratio.

15. The error diffusion control device according to claim 9, wherein the controller turns on the error diffusion function if the black data ratio is lower than the reference ratio.

16. The error diffusion control device according to claim 9, wherein the controller controls the error diffusion processor to perform error diffusion on the video data other than the black data if the black data ratio is lower than the reference ratio.

17. The error diffusion control device according to claim 9, further comprising:
a subfield mapper for transmitting the video data output from the error diffusion processor to the memory on a subfield by subfield basis.

18. An error diffusion control method for a video apparatus, the method comprising the steps of:
determining a ratio of black data to received video data, the black data representing black color in the video data;
determining an error diffusion efficiency of the video data according to the black data ratio; and
performing an error diffusion function for the video data according to the determined error diffusion efficiency.

19. The error diffusion control method according to claim 18, wherein the step of determining the ratio of the black data to the video data includes the steps of:
reading the video data from the memory on a frame by frame basis; and
determining the ratio of the black data to the video data on a frame by frame basis.

20. The error diffusion control method according to claim 18, wherein the step of determining the ratio of the black data to the video data includes the step of:
comparing a gray level of the video data with a reference gray level on a pixel by pixel basis.

21. The error diffusion control method according to claim 18, wherein the step of determining the error diffusion efficiency of the video data according to the black data ratio includes the step of:
determining the error diffusion efficiency, on a frame by frame basis, according to the black data ratio corresponding to each frame.

22. The error diffusion control method according to claim 18, wherein the step of determining an error diffusion efficiency of the video data according to the black data ratio includes the step of:
determining the error diffusion efficiency of the video data according to the black data ratio corresponding to an entire picture.

23. An error diffusion control device for a video apparatus, the device comprising:
a controller for determining a ratio of black data to received video data, the black data representing black color in the video data, and determining an error diffusion efficiency of the video data according to the determined black data ratio; and
an error diffusion processor for performing an error diffusion function for the video data according to the determined error diffusion efficiency.

24. The error diffusion control device according to claim 23, wherein the controller determines the ratio of the black data to the video data on a frame by frame basis.

25. The error diffusion control device according to claim 23, wherein the controller compares a gray level of the video data with a reference gray level on a pixel by pixel basis to identify the black data representing black color in the video data.

26. The error diffusion control device according to claim 23, wherein the controller determines the error diffusion efficiency, on a frame by frame basis, according to the black data ratio corresponding to each frame.

27. The error diffusion control device according to claim 23, wherein the controller determines an error diffusion efficiency of the video data according to the black data ratio corresponding to an entire picture.
